(19) United States
(12) Patent Application Publication
(10) Pub. No.: US 2005/0086427 A1
(43) Pub. Date: Apr. 21, 2005

(54) Systems and methods for storage filing

(76) Inventors: Robert Fozard, Los Gatos, CA (US); Desmond Young, Los Gatos, CA (US); Charlie Ghahremani, Santa Barbara, CA (US); Brian Stark, Dublin, CA (US); Rick Lund, Pleasanton, CA (US)

Correspondence Address: CARR & FERRELL LLP, 2200 GENG ROAD, PALO ALTO, CA, 94303, US

(21) Appl. No.: 10/733,991

(22) Filed: Dec. 10, 2003

Related U.S. Application Data
(60) Provisional application No. 60/512,959, filed on Oct. 20, 2003.

(51) Int. Cl. G06F 12/00; G06F 12/16; G06F 13/00; G06F 15/00

(52) U.S. Cl. 711/111; 712/34

(57) ABSTRACT

A storage filing system for a storage network includes a communication channel coprocessor, a file processor, and a storage processor. The communication channel coprocessor comprises a plurality of first symmetric processors. The communication channel coprocessor receives a request for data from a communication network. The communication channel coprocessor then processes the request to perform access control and determine a file system object for the data. The file processor comprises a plurality of second symmetric processors. The file processor determines a storage location for the data in the storage network using volume services based on the file system object. The storage processor reads the data from or writes the data to the storage location.

### CROSS-REFERENCE TO RELATED APPLICATIONS

This application claims the benefit of U.S. Provisional Application Ser. No. 60/512,959 titled “Storage Filer,” filed Oct. 20, 2003, which is incorporated herein by reference.

### BACKGROUND OF THE INVENTION

1. Field of the Invention

The present invention relates generally to the field of computer systems and more particularly to file servers for storage networks.

2. Description of the Prior Art

Communication networks continue to expand with a greater number of users accessing larger data files at faster speeds. Subsequently, file servers on these communication networks have also evolved to manage a greater number of files and handle a greater number of file requests from more nodes on the communication network. To meet this expanding demand, computer -servers have been designed to act as file servers that “serve” files to users and/or devices connected to the communication network.

FIG. 1 depicts a symbolic diagram of a workstation used as a file server in the prior art. A system 100 represents a typical architecture of first generation file servers, which are basically high-end general-purpose workstations. One example of this system 100 is a workstation from Sun Microsystems. The file server of system 100 runs standard software but is dedicated to serving files from locally attached storage. The system 100 includes five main modules: a host CPU 110, a LAN controller 120, a SCSI adapter 130, a tape controller 140, and a disk controller 160. These five main modules are interconnected by a system bus 180.

The advantages of using standard workstations for file serving are relatively low development and production costs. The system 100 can expand local storage (usually externally) via the SCSI bus 132 and allows multiple and more efficient LAN controllers. The disadvantages of using a standard workstation as a file server are that performance and reliability are low because of the general-purpose operating system and software being utilized.

FIG. 2 shows a symbolic diagram of a dedicated file server in the prior art. The system 200 has an architecture in which the hardware and software are dedicated or customized to the file serving application. One example of the system 200 is a file server from Auspex Systems of Santa Clara, Calif. The system 200 includes five main modules: a host CPU 210, a network processor 220, a system memory 230, a file processor 240, and a storage processor 250. The five modules of system 200 are also interconnected by an embedded system bus 280. Specifically, the system memory 230 is accessible by all the modules via the embedded system bus 280.

The system 200 is characterized by the host CPU 210, the network processor 220, the file processor 240 and the storage processor 250, which are dedicated to running only very specific functions. For example, the network processor 220 executes the networking protocols specifically related to file access; the storage processor 250 executes the storage protocols; the file processor 240 executes the file system procedures; and the host CPU 210 executes the remaining software functions, including non-file networking protocols. The system memory 230 buffers data between the Ethernet LAN network 222 and the disk 270, and the system memory 230 also serves as a cache for the system 200.

Because of the way the software of the system 200 is partitioned, the system 200 can be viewed as two distinct sub-systems: a host sub-system (running a general-purpose operating system (OS)) and an embedded sub-system. The advantage of using the system 200 as dedicated for file serving is principally greater performance than that which could be obtained with standard workstations of the period. Although the performance of the system 200 is greater than previous architectures such as system 100, the cost of the system 200 is much greater, and the expanding application of network file servers creates a demand for a system with an improved performance/cost ratio.

FIG. 3 depicts a symbolic diagram for a system 300 for a file server appliance in the prior art. This system 300 is built from standard computer server motherboard designs but with fully customized software. One example of the system 300 is a file server from Network Appliance of Sunnyvale, Calif. The system 300 includes four main modules: a host CPU 310, a LAN controller 320, a SCSI controller 340, and a system memory 330 that is accessible by all the modules via a system bus 370.

The host CPU 310 controls the system 300 and executes software functions using networking protocols, storage protocols, and file system procedures. The host CPU 310 has its own buses for accessing instruction and data memories, and a separate system bus is used for interconnecting the I/O devices. The SCSI controller 340 interfaces with the disk 360 and the tape 350 on each of the SCSI storage buses 352 and 362, respectively. The advantage of using a dedicated software system on a general-purpose hardware platform is an improved performance/cost ratio and improved reliability since the software is tailored only to this specific application's requirements. The major disadvantage of the system 300 is limited performance, scalability, and connectivity.

The expansion of communication networks has driven the development of storage environments. One such storage environment is called a Storage Area Network (SAN). A SAN is a network that interconnects servers and storage allowing data to be stored, retrieved, backed up, restored, and archived. Most SANs are based upon Fibre Channel and SCSI standards.

FIG. 4 depicts a symbolic diagram of a system 400 with network-attached storage (NAS) filers 410, 420, 430, 440, 450, and 460 for a SAN in the prior art. A NAS is a computer server dedicated to nothing more than file sharing. The NAS filers 410, 420, 430, 440, 450, and 460 are simple to deploy, scalable to multiple terabytes, and optimized for file sharing among heterogeneous clients. However, data-intensive applications can quickly saturate the performance and capacity limits of conventional NAS devices. When this happens, the only solution has been to add servers, effectively adding islands of data. Numerous islands of data forces users to divide and allocate their data to a large number of file servers, thus increasing costs.

Another disadvantage of the NAS filers 410, 420, 430, 440, 450, and 460 is the high management overhead because each device and its associated set of users must be individually managed. As the number of devices grows, the required management bandwidth grows accordingly. Another disadvantage of the NAS filers 410, 420, 430, 440, 450, and 460 is the inflexibility of resource deployment. In environments with multiple NAS filers such as system 400, migrating users and data among servers is a cumbersome process requiring movement of data and disruption to users. Consequently, IT managers tend to reserve some performance and capacity headroom on each device to accommodate changes in demand. This reserved headroom results in a collective over-provisioning that further exacerbates capital and overhead management issues.

What is needed is a file server with an architecture that provides improved scalability in performance, capacity, and connectivity required to interface clients to a storage network.

### SUMMARY OF THE INVENTION

The present invention addresses the problems discussed above by providing systems and methods for storage filing. A storage filing system for a storage network includes a communication channel coprocessor, a file processor, and a storage processor. The communication channel coprocessor comprises a plurality of first symmetric processors. The communication channel coprocessor receives a request for data from a communication network. The communication channel coprocessor then processes the request to perform access control and determine a file system object for the data. The file processor comprises a plurality of second symmetric processors. The file processor determines a storage location for the data in the storage network using volume services based on the file system object. The storage processor reads the data from or writes the data to the storage location.

In some embodiments, the storage filing system includes a switching system that switches information between the communication channel coprocessor, the file processor, and the storage processor. The communication channel coprocessor may execute unbounded, multi-threaded programs. The file processor may also execute unbounded, multi-threaded programs. In some embodiments, the storage filing system includes a network interface that interfaces with a plurality of other storage filing systems. The storage filing system may include a host main processor that provides high-level control of the storage filing system.

The storage filing system advantageously provides a more efficient and scalable architecture with improved performance. Specifically, the symmetric multiprocessors of the storage filing system can run unbounded, multi-threaded programs that execute faster, allow for greater flexibility in managing the execution of the programs, and provide scalability through the addition of other processors. In some embodiments, the storage filing system can be configured with other storage filing systems to provide high system availability through filer pooling, which results in a more reliable storage environment.

### BRIEF DESCRIPTION OF DRAWINGS

FIG. 1 is a symbolic diagram of a workstation used as a file server in the prior art;

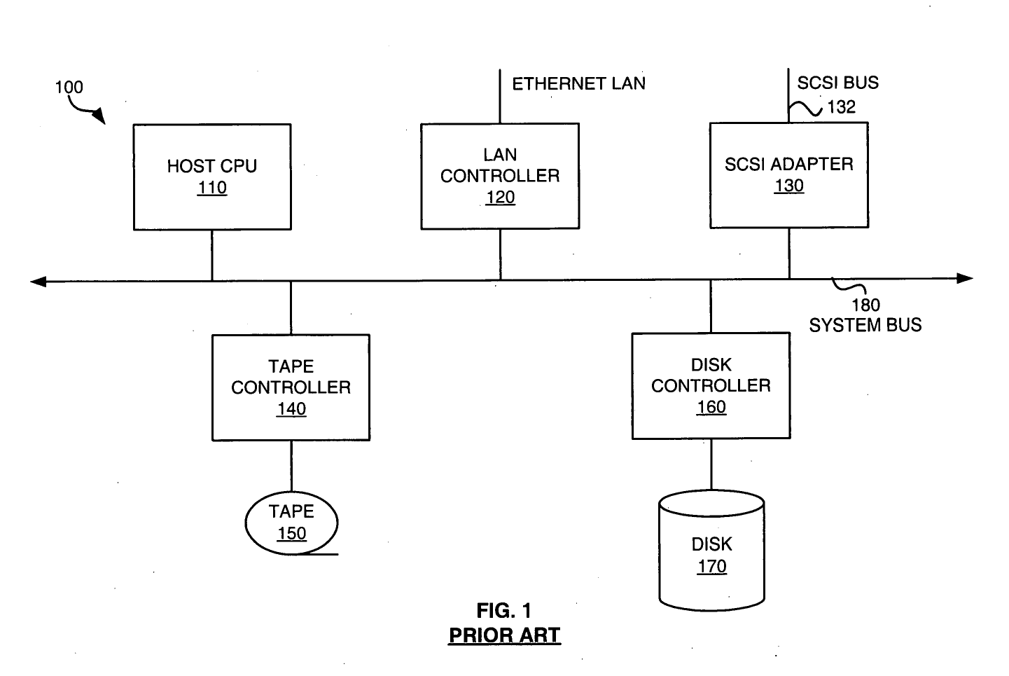

FIG. 2 is a symbolic diagram of a dedicated file server in the prior art;

FIG. 3 is a system for a file server appliance in the prior art;

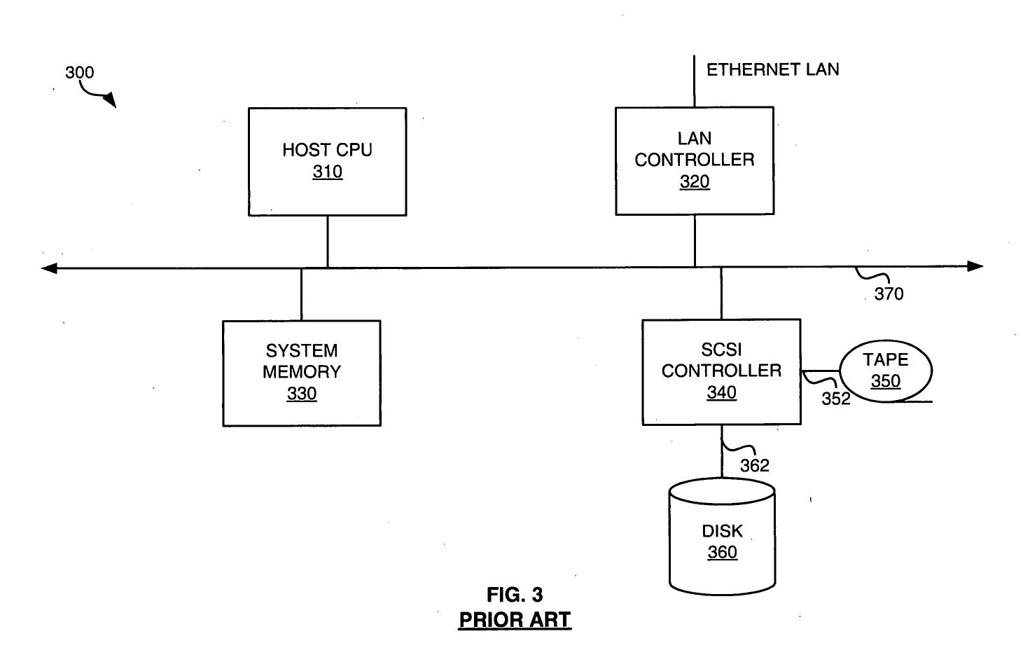

FIG. 4 is a symbolic diagram of a system with NAS filers in the prior art;

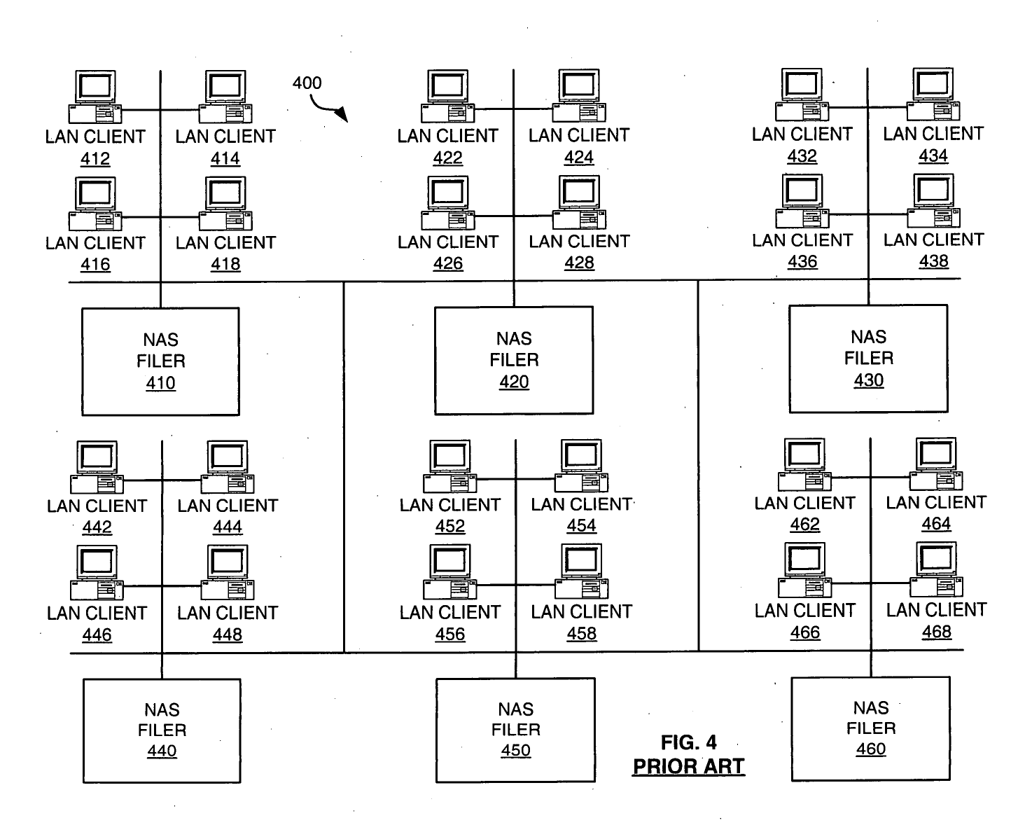

FIG. 5 is a symbolic diagram of a system with a functional view of a SAN filer in an exemplary implementation of the invention;

FIG. 6 is a symbolic diagram of a system with a component view of a SAN filer in an exemplary implementation of the invention;

FIG. 7 is a flowchart for a SAN filer in an exemplary implementation of the invention;

FIG. 8 depicts a symbolic diagram of a system with a SAN filer in a first configuration in an exemplary implementation of the invention;

FIG. 9 depicts a symbolic diagram of a system with a SAN filer in a second configuration in an exemplary implementation of the invention;

FIG. 10 depicts a symbolic diagram of a system with a SAN filer in a third configuration in an exemplary implementation of the invention;

FIG. 11 depicts a symbolic diagram of a system with a SAN filer in a fourth configuration in an exemplary implementation of the invention; and

FIG. 12 is a symbolic diagram of a system with multiple SAN filers in an exemplary implementation of the invention.

### DETAILED DESCRIPTION OF THE INVENTION

The present invention provides systems and methods for storage filing. In order to better understand the present invention, aspects of the environment within which the invention operates will first be described.

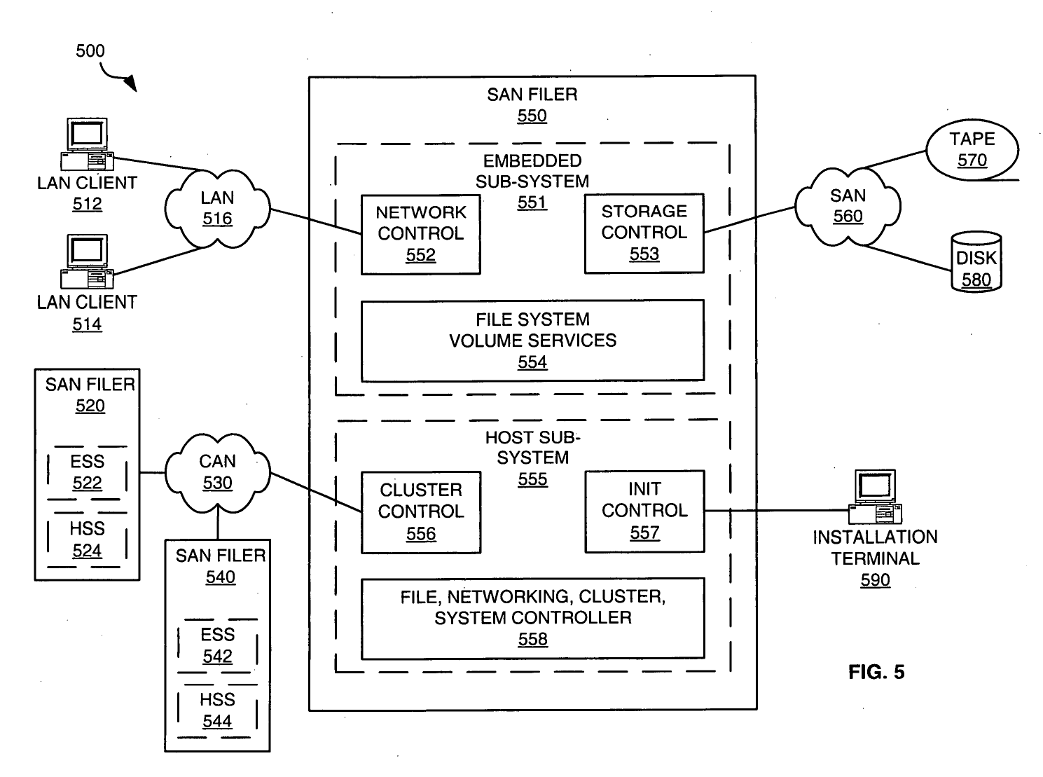

SAN Filer Configuration and Operation—FIGS. 5-7

FIG. 5 is a symbolic diagram of a system 500 with a functional view of a SAN filer 550 in an exemplary implementation of the invention. The system 500 includes Local Area Network (LAN) clients 512 and 514, a LAN 516, a SAN filer 520, a Cluster Area Network (CAN) 530, a SAN filer 540, a SAN filer 550, a SAN 560, a tape drive 570, a disk drive 580, and an installation terminal 590.

The LAN clients 512 and 514 are coupled to the LAN 516. Only two LAN clients 512 and 514 are shown for the sake of simplicity. In various embodiments, there are numerous LAN clients 512 and 514 that are coupled to the LAN 516. Other embodiments include any communication network to which users are connected.

The SAN filer 520 and the SAN filer 540 are coupled to the CAN 530. Only three SAN filers 520, 530, and 550 are shown for the sake of simplicity in FIG. 5. In various embodiments, there may be one or more SAN filers 520, 540, and 550 that are coupled to the CAN 530. The SAN filer 520 includes an embedded sub-system (ESS) 522 and a host sub-system (HSS) 524. The SAN filer 540 includes an ESS 542 and an HSS 544. The configuration and operations of the ESSs 522 and 542 and the HSSs 524 and 544 are described in further detail below.

The tape 570 and the disk 580 are coupled to the SAN 560. There are numerous tape drives, disk drives, disk arrays, tape libraries, and other dedicated and/or shared storage resources that may be coupled to the SAN 560, but they are not shown for the sake of simplicity and clarity in order to focus on the SAN filer 550. Also, other embodiments may include any storage network where storage resources are connected in addition to the SAN 560. The storage location is the location at which data on a storage resource resides.

The SAN filer 550 can be considered as a diskless server because all data such as user data, meta data, and journal data is stored on the SAN 560 on storage devices such as conventional Fibre Channel-attached disk arrays and tape libraries. In some embodiments, the SAN filer 550 does not include any captive storage unlike a NAS device. The SAN 560 serves as a multi-purpose data repository shared with application servers and other SAN filers 520 and 540.

The SAN filer 550 includes an embedded sub-system 551 and a host sub-system 555. Both the embedded sub-system 551 and the host sub-system 555 are not physical components within the SAN filer 550. Instead, the embedded sub-system 551 and the host sub-system 555 are delineations for groups of functions and/or components within the SAN filer 550.

In FIG. 5, the elements within the embedded sub-system 551 and the host sub-system 555 are representations of functions that the SAN filer 550 performs. The embedded sub-system 551 includes a network control 552, a storage control 553, and file system volume services 554. The network control 552 interfaces with the LAN 516 using LAN client network protocols. Some examples of these network protocols are Network File System (NFS), Common Internet File System (CIFS), Network Data Management Protocol (NDMP), Simple Network Management Protocol (SNMP), and Address Resolution Protocol (ARP). The network control 552 provides an interface to the file system clients through the LAN 516. In some embodiments, the SAN filer 550 has one or more Gigabit Ethernet ports, able to be link aggregated to form one or more virtual Ethernet interfaces.

The storage control 553 interfaces with the SAN 560 using SAN storage networking protocols. Some examples of the SAN storage networking protocols are FC1 to FC4 and Small Computer System Interface (SCSI). The storage control 553 provides an interface to the storage resources coupled to the SAN 560. In some embodiments, the SAN filer 550 includes one or more Fibre Channel ports to interface with the SAN 560. The file system volume services 554 perform file and volume services such as file system processes and storage volume translation services.

The host sub-system 555 includes a cluster control 556, an initialization control 557, and a file, networking, cluster, system controller 558. The cluster control 556 interfaces with the CAN 530 to other members of the clustered system using certain protocols. Some example of the protocols used by the SAN filer 550 and the CAN 530 are Domain Naming System (DNS), SNMP, and ARP. The cluster control 556 additionally supports communication between the system-level management entity of the SAN filer 550 and other management entities within the customer's data network. In some embodiments, the SAN filer 550 has one or more Ethernet ports to interface with the CAN 530. The initialization control 557 interfaces with the installation terminal 590 to provide initialization of the SAN filer 550 and provide low-level debugging of problems. In some embodiments, the SAN filer 550 has an RS-232 serial port for an interface with the installation terminal 590. The file, networking, cluster, system controller 558 provides overall management of filing, networking, and clustering operations of the SAN filer 550.

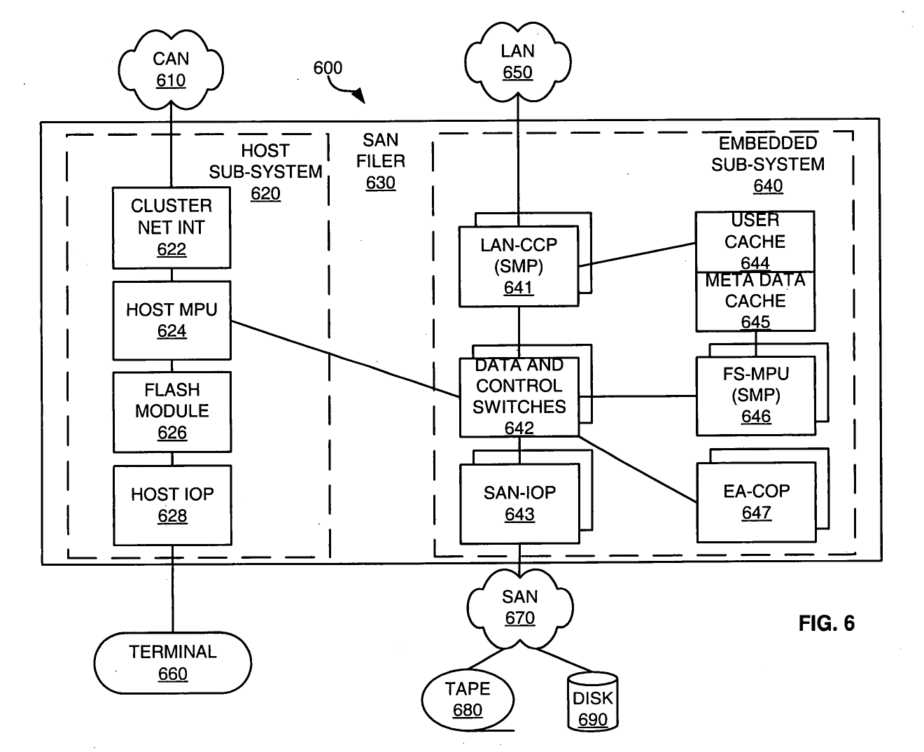

FIG. 6 is a symbolic diagram of a system 600 with a component view of a SAN filer 630 in an exemplary implementation of the invention. The system 600 includes a CAN 610, a SAN filer 630, a LAN 650, a terminal 660, a SAN 670, a tape drive 680, and a disk array 690.

The SAN filer 630 includes a host sub-system 620 and an embedded sub-system 640, which are delineations for groups of components within the SAN filer 630. The host sub-system 620 includes a cluster network interface 622, a host main processing unit (MPU) 624, a flash module 626, and a host Input/Output processor (IOP) 628. As a whole, the host sub-system 620 performs LAN network management, SAN network management, volume management, and high-level system control.

The cluster network interface 622 interfaces with the multiple nodes of the CAN 610 of other SAN filers and the host MPU 624. The cluster network interface 622 interfaces with the CAN 610 using protocols such as DNS, SNMP, and ARP. The cluster network interface 622 also interfaces with the SAN filer 630 internal components and the customer-network management entities. In some embodiments, the cluster network interface 622 has one or more Ethernet ports.

The host MPU 624 can be any processing unit configured to provide high-level control of the SAN filer 630. In general, an MPU is a processing unit configured to execute code at all levels (high and low), ultimately direct all Input/Output (I/O) operations of a system, and have a primary access path to a large system memory. Traditionally, an MPU executes the code that is the primary function of the system, which for a file server is the file system. In one embodiment, the host MPU 624 uses a general-purpose operating system such as UNIX to provide standard client networking services such as DNS, DHCP, authentication, etc. The host MPU 624 runs part of the LAN client protocols, SAN networking protocols, file system procedures, and volume management procedures. In some embodiments, the host MPU 624 does not run client applications in order to preserve the security of the system 600.

The flash module 626 holds the operating code for all processing entities within the SAN filer 630. The flash module 626 is coupled to the host MPU 624 and the host IOP 628. The host IOP 628 is an interface to the terminal 660 for initialization and debugging. In some embodiments, the host IOP 628 is an RS-232 interface. In general, an I/O processor (IOP) is a processing unit configured to execute low-level, or very limited high-level code. Typically, an IOP has lots of I/O resources. Some IOPs have a secondary or tertiary access path to the system memory, usually via Direct Memory Access (DMA). Some vendors such as IBM have called their IOPs “Channel Processors,” which are not the same as channel coprocessors.

The embedded sub-system 640 includes a LAN-channel coprocessor (CCP) 641, data and control switches 642, SAN-IOP 643, a user cache 644, a meta data cache 645, a file system-MPU (FS-MPU) 646, and an embedded application coprocessor (EA-COP) 647. In some embodiments, the embedded sub-system 640 performs the following functions: file system processes, storage volume translation services, data switching, low-level system control, and embedded (Unix) client applications. In some embodiments, the embedded sub-system 640 uses LAN client networking protocols and SAN storage networking protocols.

The LAN-CCP 641 can be an array of symmetric multi-processors (SMP) configured to interface with the LAN 650. In general, coprocessors (COP) execute high-level or specialized code such as scientific or vector routines. Typically, a coprocessor has limited or no I/O resources other than communication with the MPU. Some coprocessors have a primary or secondary access path to the system memory.

Similarly, channel coprocessors execute high-level or specialized code, tightly coupled with the MPU, such as file system or networking routines. The CCP has many I/O resources, such as an IOP, and has an access path to the system memory somewhere between a COP and an IOP. Thus, the CCP is a hybrid of the COP and IOP. A CCP is probably best suited for a dedicated (or embedded) system.

In some embodiments, the channel coprocessor is tightly coupled. Multiprocessors can be loosely or tightly coupled. When multi-processors are loosely coupled, each processor has a set of I/O devices and a large memory where it accesses most of the instructions and data. Processors intercommunicate using messages either via an interconnection network or a shared memory. The bandwidth for intercommunication is somewhat less than the bandwidth of the shared memory. When multi-processors are tightly coupled, the multi-processors communicate through a shared main memory. Complete connectivity exists between the processors and main memory, either via an interconnection network or a multi-ported memory. The bandwidth for intercommunication is approximately the same as the bandwidth of the shared memory.

In FIG. 6, the LAN-CCP 641 is illustrated with a shadow box, which represents the array of symmetric multi-processors. In terms of the symmetry of multi-processors, they are either asymmetric or symmetric. Asymmetric multi-processors differ significantly from each other with regard to one or more of the following attributes: type of central processing unit, memory access, or I/O facilities. An important distinction is that the same code often cannot execute across all processors due to their asymmetry.

Symmetric multiprocessors (SMP) are, as the name suggests, symmetric with each other. Symmetric multiprocessors have the same type of central processing unit and the same type of access path to memory and I/O. Normally, the same code can execute across all processors due to such symmetry. SMP means that an individual system can scale easily, merely by adding processors. No rewrite of operating system, file system, or other code running on an SMP array is required. SMP is the cleanest, simplest memory model for software, which results in less development and maintenance bugs, and allows new software developers to become productive more quickly. These benefits provide a more efficient business model for the system vendor.

In some embodiments, the processor in the SMP array includes a coherent memory image, where coherency is maintained via instruction and data caches. Also in some embodiments, the processor array includes a common, shared, cache-coherent memory for the storage of file system (control) meta data. The SMP architecture advantageously provides the optimum memory model in many respects, including: high speed, efficient usage and a simple programming model. Thus, the resultant simple programming model allows reduced software development cost and reduced number of errors or bugs.

In some embodiments, the LAN-CCP 641 runs unbound (state machine) and bound (conventional) multi-threaded programs. An unbound program advantageously improves performance and flexibility. In the case of unbound programs where the program is written in state-machine style, the states may be moved to another processor or a set of processors. At the system level, this feature provides the capability to continue servicing the clients of a server by moving states between multiple servers either for the purpose of balancing load or continuing after a system malfunction.

SMP uniquely allows unbound software modules to be written and executed on the system. Unbound software means tasks can run on any processor in the SMP array, or at a higher level on any system within a cluster. At a low level, unbound means the software tasks may run on any processor within an SMP array within a box. At a high level, unbound means the software tasks and client state may run on any box within a cluster. In summary, unbound software running on an SMP machine will scale more easily and cost-effectively than any other method.

A multi-threaded program can have multiple threads, each executing independently and each executing on separate processors. Obviously, a multi-threaded program operating on multiple processors achieves a considerable speedup over a single-threaded program. In some embodiments, the LAN-CCP 641 includes an acceleration module for offloading the LAN-CCP 641 of low-level networking functions such as link aggregation, address lookup, and packet classification.

The data and control switches 642 are coupled to the LAN-CCP 641, the host MPU 624, the SAN-IOP 643, the FS- MPU 646, and the EA-COP 647. The data and control switches 642 can be any device or group of devices configured to switch information between the LAN-CCP 641, the host MPU 624, the SAN-IOP 643, and the FS-MPU 646. Some examples of this information are user data, file system meta data, and SAN filer control data. In some embodiments, the data and control switches 642 also perform aggregation and conversion of switching links.

The data and control switches 642 advantageously provide a switched system for multiprocessor interconnection for the SAN filer 630 as opposed to shared buses or multi-ported memory. In a switched system, more than one communications path interconnects the functional units, and more than one functional unit is active at a time. A switched interconnect allows the system to be scaled more easily to service very large SANs. Bus-based interconnects, common in most file servers to date, do not scale with respect to bandwidth. Shared memory interconnects do not scale with respect to size and the number of interconnected elements. Only switch-based interconnects overcome these two scaling limitations.

The SAN-IOP 643 can be a multiprocessor unit configured to control and interface with the SAN 670. In some embodiments, the SAN-IOP 643 performs SAN topology discovery. In some embodiments, the SAN-IOP 643 also performs data replication services including replicating user data from cache to disk, from disk to tape, and from disk to disk.

The user cache 644 and the meta data cache 645 are coupled to each other. Also, the user cache 644 and the meta data cache 645 are coupled to the FS-MPU 646 and the LAN-CCP 641. The user cache 644 can be any cache or memory configured to store client user data. The meta data cache 645 can be any cache or memory configured to store file system directory and other control information.

The FS-MPU 646 can be any array of symmetric multiprocessors configured to run programs that execute internal networking protocols, file system protocols, and file system and storage volume services. In some embodiments, the programs are either bound or unbound. Also in some embodiments, the programs are multi-threaded. In FIG. 6, the FS-MPU 646 is illustrated with a shadow box, which represents the array of symmetric multi-processors. In some embodiments, the FS-MPU 646 cooperates with the LAN-CCP 641 and the host MPU 624. In one example, the LAN-CCP 641 handles the meta data cache 645, and the host MPU 624 handles most of the access control. Some examples of file system protocols are NFS, CIFS, and NDMP.

The embedded applications coprocessor (EA-COP) 647 provides a platform to run applications within the ESS 640 and outside the HSS 620. In some embodiments, the applications are UNIX applications. Some examples of applications include license manager and statistics gathering. The EA-COP 647 allows the execution of client applications on a general-purpose operating system but in an environment that is firewalled from the rest of the SAN filer 630. In one embodiment, the EA-COP 647 runs a low-level switch and chassis control application.

The SAN filer 630 incorporates a network processor-based platform optimized for the efficient, high speed movement of data. This is in contrast to other file-serving devices that use conventional server-class processors, designed for general-purpose computing. The specialized data-moving engine in the SAN filer 630 advantageously delivers exceptional performance.

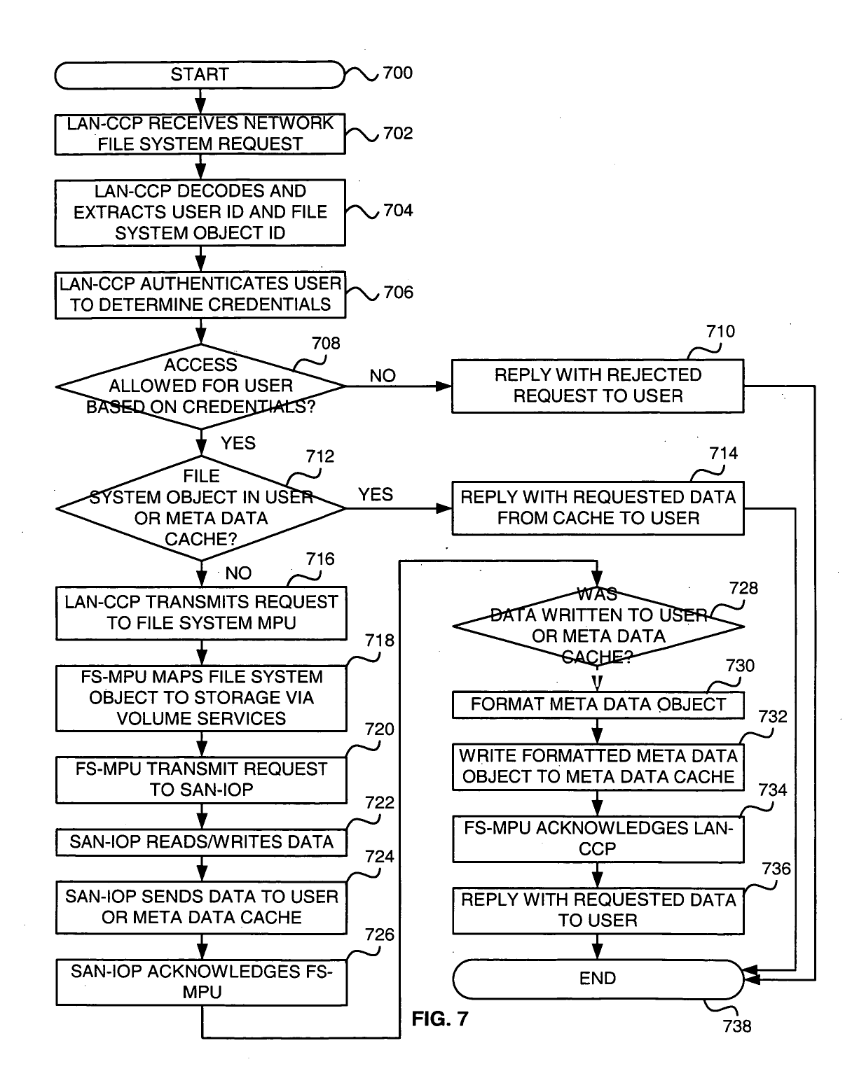

FIG. 7 depicts a flow chart for the SAN filer 630 in an exemplary implementation of the invention. FIG. 7 begins in step 700. In step 702, the LAN-CCP 641 receives a network file system request from one of the LAN clients in the LAN 650 via one of the LAN-CCP 641 media access control interfaces. In other embodiments, the request is any message, signaling, or instruction for requesting data. In step 704, the LAN-CCP 641 decodes the request and extracts the user ID and file system object ID from the network file system request. The decoding and extraction depend upon the client protocol used such as NFS or CIFS. In step 706, the LAN-CCP 641 then authenticates the user to determine the user's access credentials. In step 708, the LAN-CCP 641 checks if access is allowed for the user based on the credentials, user ID, and the file system object ID. If the user is not allowed access of the requested type, the LAN-CCP 641 replies with a rejected request to the user at the LAN client in step 710 before ending in step 738.

If the user is allowed, the LAN-CCP 641 checks whether the file system object is in the user cache 644 or the meta data cache 645 in step 712. If the file system object is in the appropriate cache, the LAN-CCP 641 replies with the requested data from the appropriate cache (the user cache 644 or the meta data cache 645) to the user at the LAN client in step 714 before ending in step 738.

If the file system object is not in the appropriate cache, the LAN-CCP 641 transmits the request to the FS-MPU 646 to further process the client's request. In step 718, the FS-MPU 646 maps or translates the file system object to the storage in the SAN 670 via volume services. In step 720, the FS-MPU 646 transmits one or more requests to the SAN-IOP 643.

The SAN-IOP 643 enters the requests into its work queue, sorting them to optimize the operation of the SAN filer 630 and then executing them at the appropriate time. In step 722, the SAN-IOP 643 reads or writes the data to the storage. In step 724, the SAN-IOP 643 sends the data to the user cache 644 or the meta data cache 645 as requested. In step 726, the SAN-IOP 643 acknowledges the FS-MPU 646. In step 728, the FS-MPU 646 checks whether the data was written to the user cache 644 or the meta data cache 645. If written to the meta data cache 645, the FS-MPU 646 formats the meta data object in step 730. In step 732, the FS-MPU 646 writes the formatted meta data object to the meta data cache 645. In step 734, the FS-MPU 646 then acknowledges the LAN-CCP 641. In step 736, the LAN-CCP 641 replies with the requested data to the user at the LAN client. FIG. 7 ends in step 738.

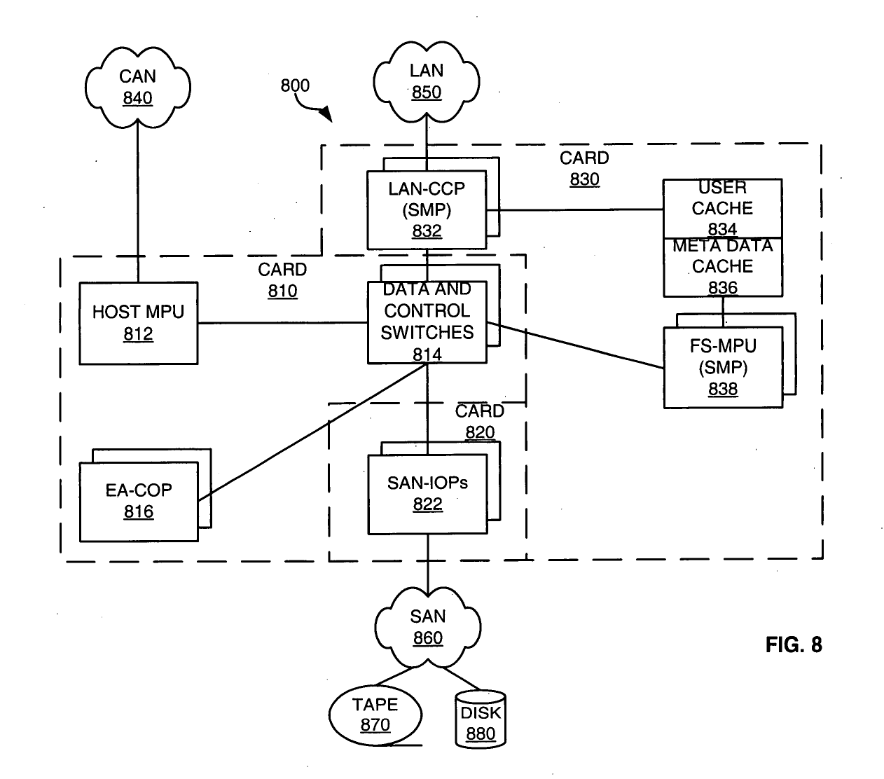

Four Configurations for the SAN Filer—FIGS. 8-11

FIGS. 8-11 depict four configurations for the SAN filer.

First Configuration for SAN Filer

FIG. 8 depicts a symbolic diagram of a system 800 with a SAN filer in a first configuration in an exemplary implementation of the invention. In this first configuration, the SAN filer comprises three circuit cards: a card 810 called the Switch and System Controller, a card 820 called the Storage Processor, and a card 830 called the File System Processor. The card 810 includes a host MPU 812, data and control switches 814, and an embedded application coprocessor (EA-COP) 816. The card 820 includes one or more SAN-IOP 822s. The card 830 includes a LAN-CCP 832, a user cache 834, a meta data cache 836, and a FS-MPU 838.

The host MPU 812 provides system control to other modules in the three circuit card chassis by the use of a high-speed microprocessor. This processor runs an advanced BSD operating system and applications on top of the operating system, which is needed for management, control, and communication. The host MPU 812 is part of the host sub-system. In some embodiments, the host sub-system also provides various other devices for the system 800 such as a boot ROM, a real-time clock, a watchdog timer, serial ports for debugging, and non-volatile storage (e.g. CompactFlash or Microdrive).

The data and control switches 814 provide interconnection between the host MPU 812, the EA-COP 816, the LAN-CCP 832, the FS-MPU 838, and the SAN-IOP 822. Physically, each circuit card connects within the system via both the data switch and the control switch. The data switch of the data and control switches 814 uses multiple serial links, each of which run at either 1.25 Gbps or 3.125 Gbps. The control switch of the data and control switches 814 uses multiple serial links, each of which run at 100 Mbps or 1 Gbps. In addition to the main data and control switches, the data and control switches 814 include a very slow-speed backplane management interconnect system for sending out-of-band control messages, such as resets and the physical connection status of a card. The EA-COP 816 runs user applications in a general-purpose operating system environment as well as background monitoring of fans, temperature and other mechanical statuses.

In this embodiment for the first configuration, the SAN-IOP 822 is organized as four independent stripes with each stripe providing a Fibre Channel port. The design of each stripe is identical, and with the exception of backplane management functions, the operation control, and management of each stripe are completely independent. Each stripe connects to the rest of the system 800 over two different data paths: control switch (CX) and data switch (DX). One purpose of the CX connection is for downloading code images from the HSS as well as low bandwidth management operations. One purpose of the DX connection is to send and receive data and some control messages to and from other cards in the chassis. Each switch connection has redundant ports for communication with a potential secondary HSS. Each stripe of the SAN-IOP 822 comprises a processor, memory, some I/O, backplane interface, and a Fibre Channel interface. The SAN-IOP 822 also includes four 1G/2G FC ports for a SAN interface.

The LAN-CCP 832 is a symmetric multi-processor array comprising two cache coherent MIPS processors with local instruction and data caches and access to two high-speed DDR SDRAM interfaces. The LAN-CCP 832 supports 8 GB of memory. In a switched version of the first configuration, the FS-MPU 838 connects to the data switch of the data and control switches 814 via a 16-bit FIFO interface supporting up to 3 Gbps operation. In both versions of the first configuration, the LAN-CCP 832 and the FS-MPU 838 interconnect via a Hyper Transport interface. The connection to the control switch is via multiple serial interfaces each supporting up to 100 Mbps operation. The LAN-CCP 832 interfaces with the LAN 850 via dual 16-bit FIFO interface to the Look Up and Classifier (LUC) element, supporting up to 3 Gbps operation. The LUC interfaces to four Gigabit Ethernet MACs.

In this embodiment for the first configuration, the FS-MPU 838 is a symmetric multi-processor array comprising two cache coherent MIPS processors with local instruction and data caches and access to two high-speed DDR SDRAM interfaces. The FS-MPU 838 supports a total of 8 GB of memory. The FS-MPU 838 connects to the data switches of the data and control switches 814 via dual 16-bit FIFO interfaces supporting up to 3 Gbps operation. The FS-MPU 838 is also connected to the control switches of the data and control switches 814 via multiple serial interfaces each supporting up to 100 Mbps operation.

The Hardware Look-Up and Classifier (LUC) interconnects the four GigE LAN MACs and the LAN-CCP 832 processor array, providing all multiplexer/demultiplexer functions between the MACs and SMP array. The LUC supports flow control in each direction. The LUC performs TCP checksums on ingress and egress packets to offer hardware acceleration to the LAN-CCP. Finally, the LUC also provides a register interface to the system for configuration and statistics of the LAN interface.

In some embodiments, this first configuration is expandable by up to four times in two ways. First, by interconnecting the DX and CX elements of each minimal size system in a hierarchical switching arrangement a 1-to-n scaling of the basic system can be accomplished. Second, by upgrading the SMP arrays from 2-processor to 4-processor elements the processing capacity may be correspondingly increased.

Second Configuration for SAN Filer

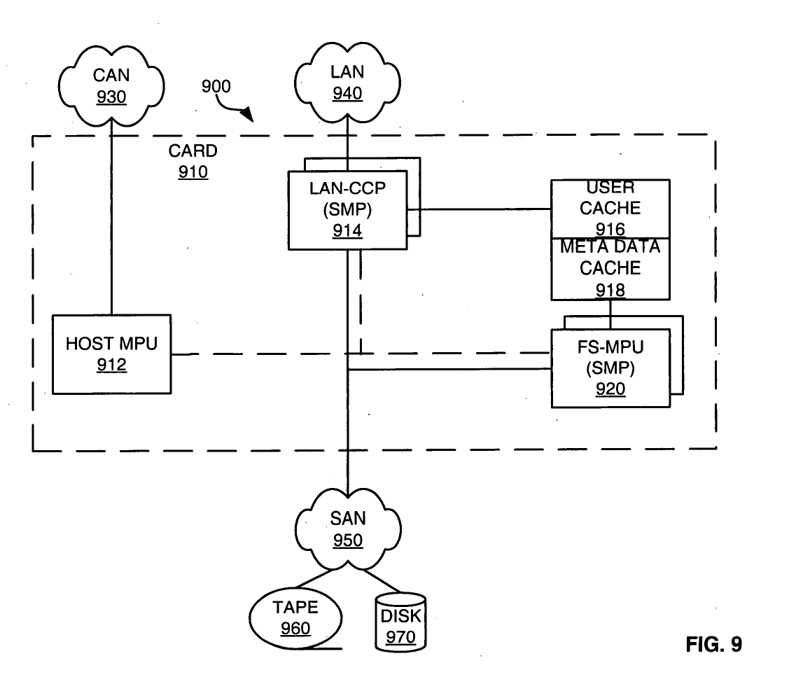

FIG. 9 depicts a symbolic diagram of a system with a SAN filer in a second configuration in an exemplary implementation of the invention. In this second configuration, the SAN filer comprises only one circuit card called card 1 910. The card 910 can be divided into four sub-sections. A first module is called the Switch & System Control (SSC) and comprises the host MPU 912. A second module is called the File System Main Processing Unit and comprises the FS-MPU 920. A third module is called the LAN Channel Coprocessor (LAN-CCP) and comprises the LAN-CCP 914 and the LUC.

A fourth module is called the SAN I/O processor (SAN-IOP). The SAN-IOP is comprised of two parts: the FC interface module, which is attached to both the FS-MPU 920 and the LAN-CCP 914; and the software module, which can be implemented in four ways: (1) as a separate task wholly contained either within the FS-MPU 920 or the LAN-CCP 914; (2) as separate tasks split between the FS-MPU 920 and the LAN-CCP 914; (3) as an SMP task wholly contained either within the FS-MPU 920 or the LAN-CCP 914; or (4) as an SMP task split between the FS-MPU 920 and the LAN-CCP 914.

The host sub-system runs on the separate CPU of the host MPU 912. The host MPU 912 also includes two 10/100 Ethernet ports for the CAN interface to the CAN 930. The LAN-CCP 914 comprises a 2-processor SMP array. Also, the LAN-CCP 914 has two or four GigE ports for the LAN interface. The FS-MPU 920 comprises a 2-processor SMP array. The FS-MPU 920 also includes two or four 1G/2G FC ports for the SAN interface with the SAN 950. The card 910 includes one RS-232c port for the initialization interface. The user cache 916 and the meta data cache 918 are 2 GB to 8 GB caches. The elements within the card 910 are interconnected by direct-connect data and control paths as opposed to the data and control switches in other embodiments.

Third Configuration for SAN Filer

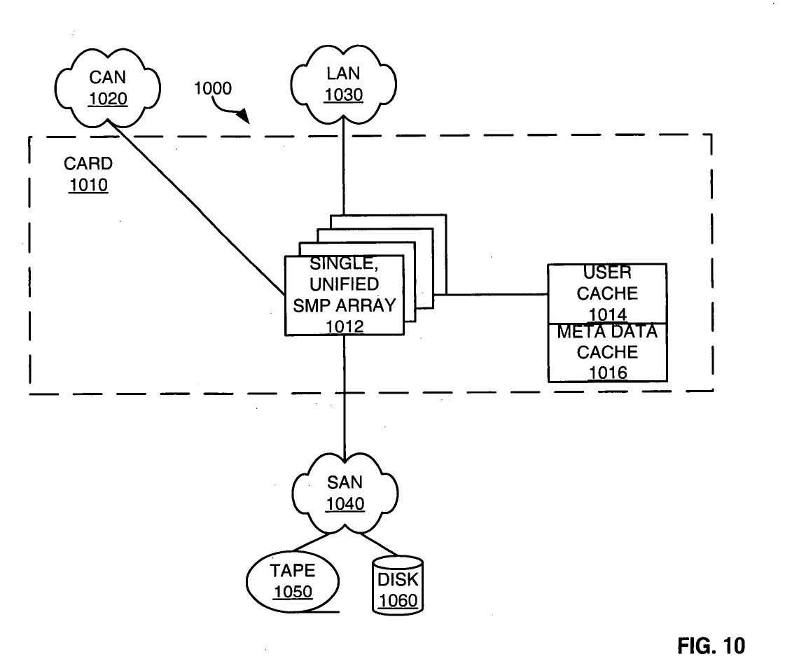

FIG. 10 depicts a symbolic diagram of a system with a SAN filer in a third configuration in an exemplary implementation of the invention. In this third configuration, the SAN filer includes a single circuit card 1010. The card 1010 includes a single, unified SMP array 1012, a user cache 1014, and a meta data cache 1016. The single, unified SMP array 1012 comprises one large 4-processor SMP array executing all the system functions of the above described FS-MPU, LAN-CCP, SAN-IOP, and host MPU. The single, unified SMP array 1012 includes two or four GigE ports for the LAN interface to the LAN 1030. The single, unified SMP array 1012 also includes two or four 1G/2G FC ports for the SAN interface to the SAN 1040. The single, unified SMP array 1012 includes two 10/100 Ethernet ports for the CAN interface to the CAN 1020. The card 1010 includes one RS-232c port for the initialization interface. The card 1010 includes a Hardware Look-up and Classifier and internal data and control paths. The user cache 1014 and the meta data cache 1016 comprise 2 GB to 8 GB caches.

Fourth Configuration for SAN Filer

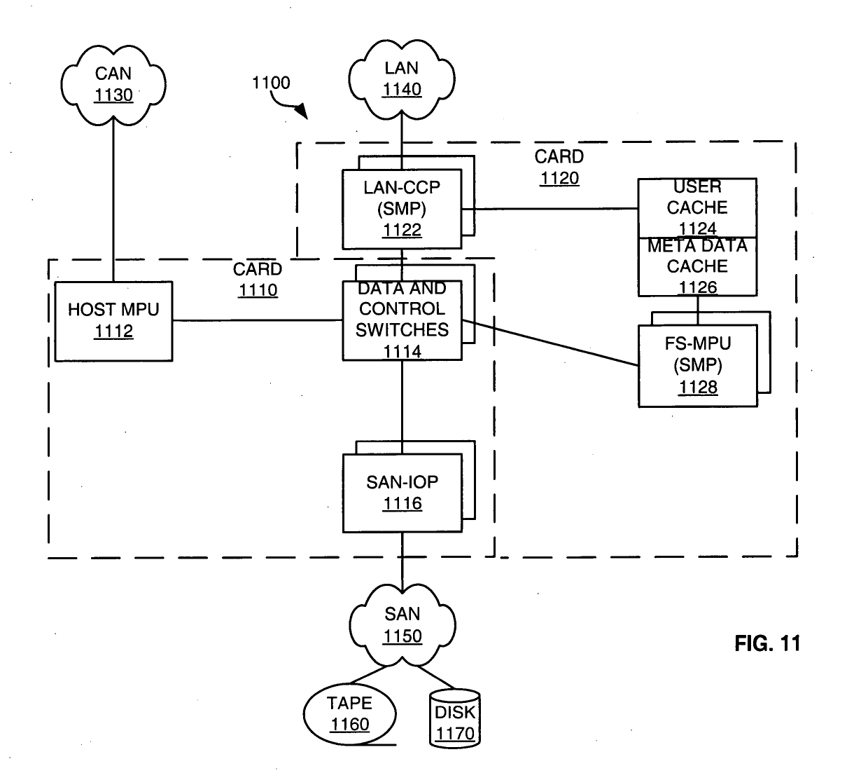

FIG. 11 depicts a symbolic diagram of a system with a SAN filer in a fourth configuration in an exemplary implementation of the invention. In this fourth configuration, the SAN filer comprises two circuit cards: card 1110 and card 1120. Card 1110 comprises the host MPU 1112, the data and control switches 1114, and the SAN-IOP 1116. Card 1120 comprises the LAN-CCP 1122, the user cache 1124, the meta data cache 1126, and the FS-MPU 1128.

The host MPU 1112 comprises a 2-processor SMP array. The host MPU 1112 includes two 10/100/1000 Ethernet ports for the CAN interface to the CAN 1130. The SAN-IOP 1116 comprises a 2-processor SMP array. The SAN-IOP 1116 also comprises four to eight 1G/2G FC ports for the SAN interface to the SAN 1150. The LAN-CCP 1122 comprises a 4-processor SMP array. The LAN-CCP 1122 also includes four to eight GigE ports for the LAN interface to the LAN 1140. The user cache 1124 and the meta data cache 1126 comprise 2 GB to 8 GB caches. The FS-MPU 1128 comprises a 4-processor SMP array. The card 1120 includes one RS-232c port for the initialization interface and a Hardware Look-up Classifier.

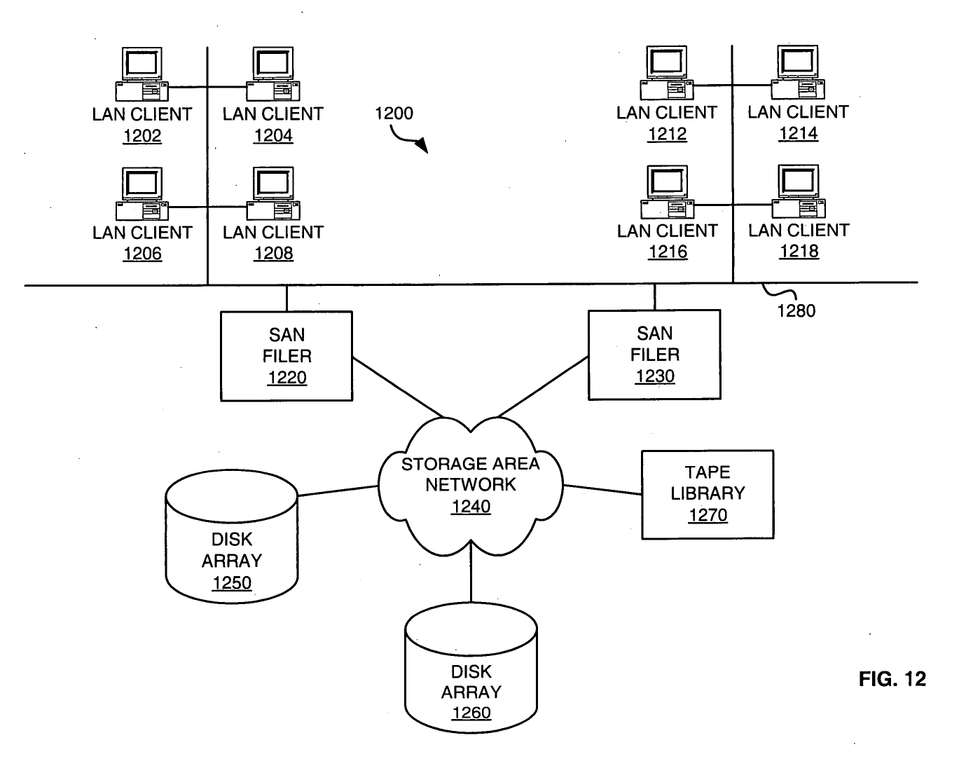

Multiple SAN Filer Environment—FIG. 12

FIG. 12 depicts a symbolic diagram of a system with multiple SAN filers in an exemplary implementation of the invention. The system 1200 includes LAN clients 1202, 1204, 1206, and 1208, LAN clients 1212, 1214, 1216, and 1218, SAN filer 1220, SAN filer 1230, storage area network 1240, disk array 1250, disk array 1260, and tape library 1270. A network link 1280 interconnects the LAN clients 1202, 1204, 1206, and 1208, the LAN clients 1212, 1214, 1216, and 1218, the SAN filer 1220, and the SAN filer 1230. The SAN 1240 is connected to the SAN filer 1220, the SAN filer 1230, the disk array 1250, the disk array 1260, and the tape library 1270.

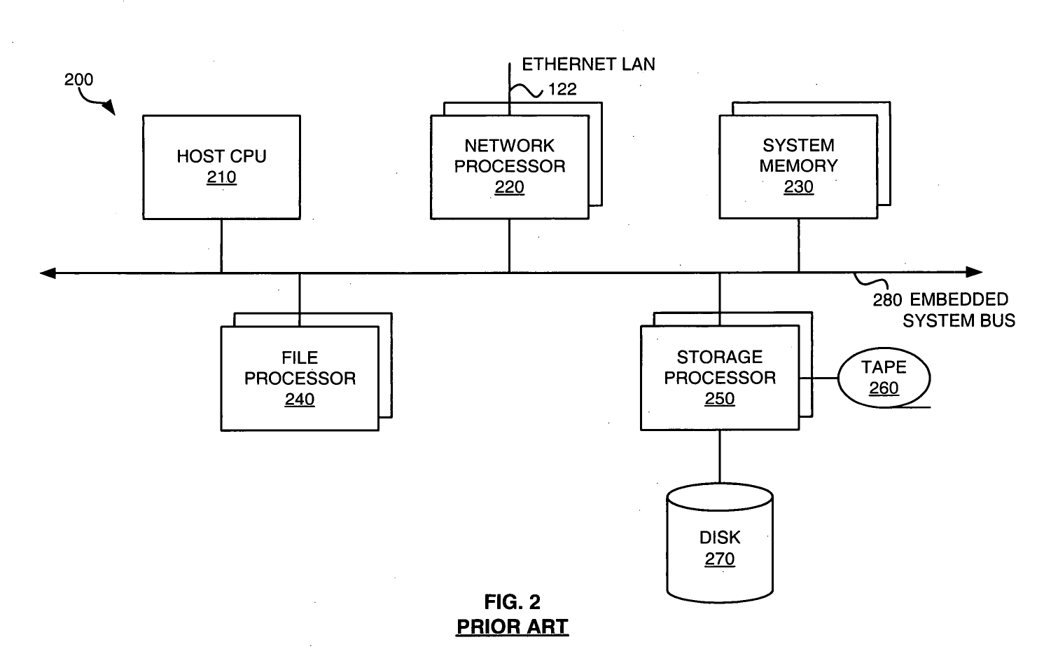

Only two SAN filers 1220 and 1230 are shown in FIG. 12 for the sake of simplicity. Other embodiments may include numerous SAN filers to expand file storage. One advantage the SAN filers 1220 and 1230 provide is high system availability through filer pooling. A multiple SAN filer configuration such as the system 1200 in FIG. 2 eliminates single points of failure in two ways. First, the multiple SAN filer configuration permits users or servers to access data through any SAN filer in a multiple-filer environment. If a SAN filer 1220 is taken off-line or is experiencing excessive workload, users may easily be migrated to another SAN filer 1230 with no changes in IP address or server names required. For example if LAN client 1202 is accessing the disk array 1260 through SAN filer 1220, and SAN filer 1220 fails or is overloaded, the LAN client 1202 can still access the disk array 1260 through SAN filer 1230.

Second, filer pooling means that any filer can access data from any storage array. In the SAN filer environment such as system 1200, all data, including file system directories and meta data, are stored on shared devices accessible over the SAN 1240. Any SAN filer can access the data regardless of which SAN filer stored it. Because SAN filers offer petabyte addressability, each filer has essentially unlimited ability to directly access large pools of data. Unlike most virtual file system implementations, no redirection by another filer or meta data server is required. By eliminating both single-points-of-failure and performance bottlenecks, this architecture creates a highly robust storage environment.

The SAN filer's broad interoperability significantly boosts the return-on-investment for the total solution. Unlike systems that are built around vendor's storage device or infrastructure, SAN filers are compatible with a wide range of arrays, switches, and tape libraries. This interoperability has powerful implications for both reducing the cost of high-availability storage and simplifying its integration.

Another advantage is non-disruptive integration. The SAN filer's interoperability extends beyond infrastructure and arrays to storage and device management software as well. This allows SAN filers to integrate with existing procedures and practices without disruption. From data backup processes to SAN management, SAN filers provide a solution that works with existing procedures, rather than replacing them.

The SAN filer also enhances the return on investment by leveraging storage investments already in place. An existing SAN environment can be shared among application servers and SAN filers. Alternatively, components can be redeployed to create a dedicated file storage environment that is accessed by SAN filers. Either way, existing infrastructure can become an integral element of the future file storage solution.

Another advantage is multi-tiered storage flexibility. Not all applications demand the same level of performance and data availability, and it makes sense that data storage systems should have the flexibility to meet these varying requirements. But most file-storage systems are designed around proprietary storage and have little or no ability to include other vendors' solutions. SAN filers have the flexibility to store data on arrays ranging from high-end, high performance sub-systems to the emerging cost-effective SATA-based sub-systems. SAN filers allow IT managers to optimize storage delivery by defining and applying different service levels to specific application requirements. Less demanding applications can be directed to lower-performance, lower-cost storage solutions, while higher end, more expensive storage investments can be reserved for the mission-critical applications that demand that class of storage.

Another advantage is interchangeability. SAN filers share one critical attribute with common network infrastructure components such as switches and routers: interchangeability. Just as data can be flexibly routed through the local area network, SAN filers permit file services to be migrated transparently between filers to support load balancing or availability requirements. If needed, one SAN filer can be replaced with another without disrupting network operations and without moving data.

In some embodiments, another advantage is the stateless architecture with n-way clustering for SAN filers. The SAN filer hardware and software are inherently stateless. All records of ongoing transaction are journaled to SAN-based disk, rather than being stored in the filer itself. With no disk and no non-volatile RAM on board, the SAN filer delivers n-way clustering with capabilities that go beyond conventional clustering. N-way clustering allows one filer to replace another without requiring cache coherency. As with a Fibre Channel fabric switch, the only information that is shared between SAN filers on an ongoing basis is health monitoring and SAN environment mapping. Conventional clustering, by contrast, usually requires that the device maintain cache coherency to facilitate failover. SAN filers remain independent until switchover occurs: at that moment, a SAN filer simply resumes activities where the previous filer left off.

Those skilled in the art will appreciate variations of the above-described embodiments that fall within the scope of the invention. As a result, the invention is not limited to the specific examples and illustrations discussed above, but only by the following claims and their equivalents.

1. A storage filing system for a storage network, the storage filing system comprising:
a communication channel coprocessor comprising a plurality of first symmetric processors and configured to receive a request for data from a communication network and process the request to perform access control and determine a file system object for the data;
a file processor comprising a plurality of second symmetric processors and configured to determine a storage location for the data in the storage network using volume services based on the file system object; and
a storage processor connected to the storage network and configured to read the data from or write the data to the storage location.

2. The storage filing system of claim 1 further comprising a switching system configured to switch information between the communication channel coprocessor, the file processor, and the storage processor.

3. The storage filing system of claim 1 wherein the communication channel coprocessor and the file processor are configured to execute unbounded programs.

4. The storage filing system of claim 1 wherein the communication channel coprocessors and the file processors are configured to execute multi-threaded programs.

5. The storage filing system of claim 1 further comprising:
a user cache configured to store the data; and
a meta data cache configured to store file system information.

6. The storage filing system of claim 1 further comprising a network interface configured to interface with a plurality of other storage filing systems.

7. The storage filing system of claim 1 further comprising a host main processor configured to provide high-level control of the storage filing system.

8. A method of operating a storage filing system for a storage network, the method comprising the steps of:
receiving a request for data from a communication network into a communication channel coprocessor comprising a plurality of first symmetric processors;
processing the request in the communication channel coprocessor to perform access control and determine a file system object for the data;
determining a storage location for the data in a storage network using volume services based on the file system object in a file processor comprising a plurality of second symmetric processors; and
in a storage processor connected to the storage network, reading the data from or writing the data to the storage location.

9. The method of claim 8 further comprising switching information in a switching system between the communication channel coprocessor, the file processor, and the storage processor.

10. The method of claim 8 further comprising executing unbounded programs in the communication channel coprocessor and the file processor.

11. The method of claim 8 further comprising executing multi-threaded programs in the communication channel coprocessor and the file processor.

12. The method of claim 8 further comprising:
storing the data in a user cache; and
storing file system information in a meta data cache.

13. The method of claim 8 further comprising interfacing with a plurality of other storage filing systems through a network interface.

14. The method of claim 8 further comprising providing a high-level control of the storage filing system in a host main processor.

15. A storage filing system for storage networks, the storage filing system comprising:
means for receiving a request for data from a communication network into a communication channel coprocessor comprising a plurality of first symmetric processors;
means for processing the request in the communication channel coprocessor to perform access control and determine a file system object for the data;
means for determining a storage location for the data in a storage network using volume services based on the file system object in a file processor comprising a plurality of second symmetric processors; and
means for reading the data from or writing the data to the storage location in a storage processor connected to the storage network.

16. The storage filing system of claim 15 further comprising means for switching information between the communication channel coprocessor, the file processor, and the storage processor.

17. The storage filing system of claim 15 further comprising means for executing unbounded programs in the communication channel coprocessor and the file processor.

18. The storage filing system of claim 15 further comprising means for executing multi-threaded programs in the communication channel coprocessor and the file processor.

19. The storage filing system of claim 15 further comprising
means for storing the data in a user cache; and
means for storing file system information in a meta data cache.

20. The storage filing system of claim 15 further comprising means for interfacing with a plurality of other storage filing systems through a network interface.

21. The storage filing system of claim 15 further comprising means for providing a high-level control of the storage filing system in a host main processor.

22. A storage filing system for a storage network, the storage filing system comprising:
a channel coprocessor comprising first symmetric processors and configured to perform access control for users;
a file processor comprising second symmetric processors and configured to perform file services and volume services; and
a storage processor configured to perform data transactions over the storage network.

23. The storage filing system of claim 22 further comprising a switching system configured to switch information between the communication channel coprocessor, the file processor, and the storage processor.

24. The storage filing system of claim 22 wherein the communication channel coprocessor and the file processor are configured to execute unbounded programs.

25. The storage filing system of claim 22 wherein the communication channel coprocessors and the file processors are configured to execute multi-threaded programs.

26. The storage filing system of claim 22 further comprising:
a user cache configured to store the data; and
a meta data cache configured to store file system information.

27. The storage filing system of claim 22 further comprising a network interface configured to interface with a plurality of other storage filing systems.

28. The storage filing system of claim 22 further comprising a host main processor configured to provide high-level control of the storage filing system.

29. A system for a storage network comprising:
a communication network;
a first storage filing system comprising:
a first channel coprocessor comprising first symmetric processors and configured to perform access control for users;
a first file processor comprising a plurality of second symmetric processors and configured to perform file services and volume services; and
a first storage processor configured to perform data transactions over the storage network; and
a first interface to communicate over the communication network; and
a second storage filing system comprising:
a second channel coprocessor comprising third symmetric processors and configured to perform the access control for the users;
a second file processor comprising fourth symmetric processors and configured to perform the file services and the volume services; and
a second storage processor configured to perform the data transactions over the storage network; and
a second interface to communicate with the first storage filing system over the communication network.
